(19) United States
(12) Patent Application Publication
(10) Pub. No.: US 2005/0119141 A1
(43) Pub. Date: Jun. 2, 2005

(54) Stability enhancement of solutions containing antimicrobial agents

(76) Inventors: Irene Quenville, Oswego, NY (US); Erning Xia, Penfield, NY (US); Stephen Maier, Brockport, NY (US); O. William Lever JR., Pittsford, NY (US); David J. Heiler, Avon, NY (US); Alyce K. Dobie, Williamson, NY (US)

Correspondence Address: RITA D. VACCA;BAUSCH & LOMB INCORPORATED, ONE BAUSCH & LOMB PLACE, ROCHESTER, NY, 14604-2701, US

(21) Appl. No.: 10/725,233

(22) Filed: Dec. 1, 2003

(51) Int. Cl. C11D 1/00

(52) U.S. Cl. 510/112

(57) ABSTRACT

Methods for enhancing biocidal efficacies and product stability of lens care solutions comprising packaging such solutions in containers fabricated from poly(ethylene terephalate).

### FIELD OF THE INVENTION

The present invention relates to stability enhancement of compositions useful for cleaning and disinfecting contact lenses. More specifically, the present invention relates to lens care solutions produced from compositions containing antimicrobial agents for cleaning and disinfecting contact lenses and the use of packaging to enhance solution stability and increase solution shelf-life.

### BACKGROUND OF THE INVENTION

Conventionally, contact lenses have been classified into water-nonabsorptive contact lenses and water-absorptive contact lenses, and classified into hard contact lenses and soft contact lenses. Both hard and soft contact lenses may develop deposits or stains of proteins and/or lipids while the lens is worn in the eye. Such stains may cause a deterioration in the comfort of a lens during wear or cause eye problems such as blurred eyesight or congestion of the cornea. Accordingly, it is essential to apply a cleaning treatment to a contact lens in order to safely and comfortably use contact lenses every day.

To effectively clean contact lenses, solutions formulated for cleaning contact lenses having cleaning or removal effect over one or more stains are typically used. Solutions formulated for cleaning contact lenses may include therein a surfactant useful as a cleaning component. Contact lens cleaning solutions incorporating nonionic surfactants such as a polyoxyalkylene block copolymer such as a polyoxyethylene-polyoxypropylene block copolymer or a derivative thereof are known.

Contact lens care solutions also typically include antimicrobial agents for the purpose of disinfecting contact lenses or for the purpose of preserving the solution. Antimicrobial agents are present in such solutions at levels that ensure biocidal efficacy throughout the product or solution shelf-life.

In packaging contact lens care solutions, high density polyethylene (HDPE) bottles are standard. HDPE bottle resins contain numerous additives, such as antioxidants, plasticizers, flame retardants, and the like. HDPE bottle resin additives have the ability to migrate or “bloom” to the surfaces of the bottle and potentially interact with lens care solution ingredients. This “blooming” phenomenon of HDPE resin additives is typically exacerbated by the presence of surfactants, such as those found useful as cleaning components in lens care solutions.

Accordingly; it would be desirable to have a material for contact lens care solution packaging that does not contain numerous additives that tend to migrate or bloom to the surfaces of said packaging.

### SUMMARY OF THE INVENTION

The present invention provides packaging in the form of clear bottles produced from poly(ethylene terephalate) (PET) resin useful in packaging lens care solutions, which include surfactants and antimicrobial agents. Unexpectedly, significant improvements in chemical stability and disinfection efficacy were observed in such lens care solutions packaged in PET bottles.

Another aspect of the present invention comprises a method of enhancing antimicrobial efficacy of a lens care solution comprising packaging said solution in a container formed of PET resin.

Another method of the present invention comprises enhancing lens care solution stability and hence shelf-life by packaging said solution in a container formed of PET resin.

### BRIEF DESCRIPTION OF THE DRAWINGS

FIG. 1 is a graph depicting antimicrobial agent stability profile of Test Solution 1 in PET vs. HDPE packaging;

FIG. 2 is a graph depicting antimicrobial agent stability profile of Test Solution 2 in PET vs. HDPE packaging;

FIG. 3 is a bar chart illustrating biocidal efficacy of Test Solution 1 against Fusarium solani in PET vs. HDPE packaging; and

FIG. 4 is a bar chart illustrating biocidal efficacy of Test Solution 2 against Candida albicans in PET vs. HDPE packaging.

### DETAILED DESCRIPTION OF THE INVENTION

The present invention provides lens care solution packaging in the form of clear bottles produced from poly(ethylene terephalate) (PET) resin. Contact lens care solutions comprising one or more cleaning surfactants and one or more antimicrobial agents unexpectantly have been found to have enhanced chemical stability and enhanced biocidal efficacy when packaged in containers such as but not limited to bottles formed from PET resin.

Compositions found to have enhanced properties when packaged in PET containers are aqueous solutions. Such compositions may include one or more nonionic polyether surfactants. Suitable nonionic polyether surfactants for use in compositions of the present invention include for example but are not limited to Pluronic P123™ (BASF, Mount Olive, N.J.) having a hydrophilic/lipophilic balance (HLB) of 8, Pluronic L42™ (BASF) having a HLB of 8, Pluronic L62™ (BASF) having a HLB of 7, Pluronic L72™ (BASF) having a HLB of 7, Pluronic L92™ (BASF) having a HLB of 6, Pluronic P103™ (BASF) having a HLB of 9, Pluronic R 12R3™ (BASF) having a HLB of 7, Pluronic R 17R1™ (BASF) having a HLB of 3, Pluronic R 17R2™ (BASF) having a HLB of 6, Pluronic R 31R1™ (BASF) having a HLB of 1, Pluronic R 31R2™ (BASF) having a HLB of 2, Pluronic R 31R4™ (BASF) having a HLB of 7, Tetronic 7, Tetronic 701™ (BASF) having a HLB of 3, Tetronic 702™ (BASF) having a HLB of 7, Tetronic 901™ (BASF) having a HLB of 3, Tetronic 1101™ (BASF) having a HLB of 2, Tetronic 1102™ (BASF) having a HLB of 6, Tetronic 1301™ (BASF) having a HLB of 2, Tetronic 1302™ (BASF) having a HLB of 6, Tetronic 1501™ (BASF) having a HLB of 1, Tetronic 1502™ (BASF) having a HLB of 5, Tetronic R 50R1™ (BASF) having a HLB of 3, Tetronic R 50R4™ (BASF) having a HLB of 9, Tetronic R 70R1™ (BASF) having a HLB of 3, Tetronic R 70R2™ (BASF) having a HLB of 5, Tetronic R 70R4™ (BASF) having a HLB of 8, Tetronic R 90R1™ (BASF) having a HLB of 2, Tetronic R 90R4™ (BASF) having a HLB of 7, Tetronic R 110R1™ (BASF) having a HLB of 2, Tetronic R 110R2™ (BASF) having a HLB of 4, Tetronic R 110R7™ (BASF) having a HLB of 10, Tetronic R 130R1™ (BASF) having a HLB of 1, Tetronic R 130R2™ (BASF) having a HLB of 3, Tetronic R 150R1™ (BASF) having a HLB of 1, Tetronic R 150R4™ (BASF) having a HLB of 5 and Tetronic R 150R8™ (BASF) having a HLB of 11. Such nonionic polyether surfactants are preferably employed in compositions of the present invention in amounts ranging from about 0.1 to about 6.0 weight percent, more preferably from about 0.2 to about 5.0 weight percent to achieve cleaning efficacy.

Compositions found to have enhanced properties when packaged in PET containers include at least one antimicrobial agent. Suitable antimicrobial agents include quaternary ammonium salts that do not include significant hydrophobic portions, e.g., alkyl chains comprising more than six carbon atoms. Suitable quaternary ammonium salts for use in the present invention include for example but are not limited to poly[(dimethyliminio)-2-butene-1,4-diyl chloride] and [4-tris(2-hydroxyethyl)ammonio]-2-butenyl-ω-[tris(2-hydroxyethyl)ammonio]dichloride (Chemical Abstracts Registry No. 75345-27-6) generally available as Polyquaternium 1 (Onyx Corporation, Montpelier, Vt.). Also suitable are biguanides and their salts, such as 1,1′-hexamethylene-bis[5-(2-ethylhexyl)biguanide](Alexidine) and poly(hexamethylene biguanide)(PHMB) available from ICI Americas, Inc., Wilmington, Del. under the trade name Cosmocil CQ, benzalkonium chloride (BAK) and sorbic acid.

One or more antimicrobial agents are present in the subject compositions in an amount effective for disinfecting a contact lens, as found in conventional lens soaking and disinfecting solutions. Preferably, the one or more antimicrobial agents will be used in a disinfecting amount or an amount from about 0.0001 to about 0.5 weight percent by volume. A disinfecting amount of an antimicrobial agent is an amount that will at least partially reduce the microorganism population in the formulations employed. Preferably, a disinfecting amount is that which will reduce the microbial burden by two log orders in four hours and more preferably by one log order in one hour. Most preferably, a disinfecting amount is an amount that will eliminate the microbial burden on a contact lens when used in the regimen for the recommended soaking time (FDA Chemical Disinfection Efficacy Test—July, 1985 Contact Lens Solution Draft Guidelines). Typically, such agents are present in concentrations ranging from about 0.00001 to about 0.5 weight percent based on volume (w/v), and more preferably, from about 0.00003 to about 0.05 weight percent.

Compositions having enhanced properties when packaged in PET containers may also contain various other components including for example, but not limited to one or more chelating and/or sequestering agents, one or more osmolarity adjusting agents, one or more surfactants, one or more buffering agents and/or one or more wetting agents.

Chelating agents, also referred to as sequestering agents, are frequently employed in conjunction with an antimicrobial agent. These agents bind heavy metal ions that might otherwise react with the lens and/or protein deposits and collect on the lens. Chelating agents are well known in the art, and examples of preferred chelating agents include ethylenediaminetetraacetic acid (EDTA) and its salts, especially disodium EDTA. Such agents are normally employed in amounts from about 0.01 to about 2.0 weight percent, more preferably from about 0.01 to about 0.3 weight percent. Other suitable sequestering agents include for example gluconic acid, citric acid, tartaric acid and their salts, e.g., sodium salts.

Compositions having enhanced properties when packaged in PET containers may be designed for a variety of osmolarities, but it is preferred that the compositions are iso-osmal with respect to eye fluids. Specifically, it is preferred that the compositions have an osmotic value of less than about 350 mOsm/kg, more preferably from about 175 to about 330 mOsm/kg, and most preferably from about 260 to about 310 mOsm/Kg. One or more osmolarity adjusting agents may be employed in the composition to obtain the desired final osmolarity. Examples of suitable osmolarity adjusting agents include, but are not limited to sodium and potassium chloride, monosaccharides such as dextrose, calcium and magnesium chloride, and low molecular weight polyols such as glycerin and propylene glycol. Typically, these agents are used individually in amounts ranging from about 0.01 to 5 weight percent and preferably, from about 0.1 to about 2 weight percent.

Compositions having enhanced properties when packaged in PET containers preferably have an ophthalmically compatible pH, which generally will range between about 6 to about 8, and more preferably between 6.5 to 7.8, and most preferably about 7 to 7.5. One or more conventional buffers may be employed to obtain the desired pH value. Suitable buffers include for example but are not limited to borate buffers based on boric acid and/or sodium borate, phosphate buffers based on Na₂HPO₄, NaH₂PO₄ and/or KH₂PO₄, citrate buffer based on potassium citrate and/or citric acid, sodium bicarbonate and combinations thereof. Generally, buffers will be used in amounts ranging from about 0.05 to about 2.5 weight percent, and preferably, from about 0.1 to about 1.5 weight percent.

Such compositions may likewise include a wetting agent to facilitate the composition wetting the surface of a contact lens. Within the art, the term “humectant” is also commonly used to describe these materials. A first class of wetting agents is polymer wetting agents. Examples include for example but are not limited to polyvinyl alcohol (PVA), polyvinyl pyrrolidone (PVP), cellulose derivatives and polyethylene glycol. Cellulose derivatives and PVA may be used to also increase viscosity of the composition, and offer this advantage if desired. Specific cellulose derivatives include for example but are not limited to hydroxypropyl methyl cellulose, carboxymethyl cellulose, methyl cellulose, hydroxyethyl cellulose, and cationic cellulose derivatives. As disclosed in U.S. Pat. No. 6,274,133, cationic cellulosic polymers help prevent the accumulation of lipids and proteins on a hydrophilic lens surface. Such polymers include commercially available water soluble polymers available under the CTFA (Cosmetic, Toiletry, and Fragrance Association) designation Polyquaternium-10, including the cationic cellulosic polymers available under the trade name UCARE® Polymer from Amerchol Corp., Edison, N.J. Generally, these cationic cellulose polymers contain quaternized N,N-dimethyl amino groups along the cellulosic polymer chain.

Another suitable class of wetting agents is non-polymeric wetting agents. Examples include glycerin, propylene glycol, and other non-polymeric diols and glycols.

The specific quantities of wetting agents used in the present invention will vary depending upon the application. However, the wetting agents will typically be included in an amount from about 0.01 to about 5 weight percent, preferably from about 0.1 to about 2 weight percent.

It will be understood that some composition constituents possess more than one functional attribute. For example, cellulose derivatives are suitable polymeric wetting agents, but are also referred to as “viscosity increasing agents” to increase viscosity of the composition if desired. Glycerin is a suitable non-polymeric wetting agent but is also may contribute to adjusting tonicity.

Compositions found to have enhanced properties when packaged in PET containers may also include at least one ophthalmically acceptable surfactant, which may be either cationic, anionic, nonionic or amphoteric. Preferred surfactants are amphoteric or nonionic surfactants. The surfactant should be soluble in the aqueous solution and non-irritating to eye tissues. The surfactant serves mainly to facilitate removal of non-proteinaceous matter on the contact lens.

Many nonionic surfactants comprise one or more chains or polymeric components having oxyalkylene (—O—R—) repeat units wherein R has 2 to 6 carbon atoms. Representative non-ionic surfactants comprise block polymers of two or more different kinds of oxyalkylene repeat units, which ratio of different repeat units determines the HLB of the surfactant. Typical HLB values for surfactants found to be suitable are in the range of 18 or above. Examples of such poloxamers are polyoxyethylene, polyoxypropylene block copolymers available under the trade name Pluronic (BASF). Poloxamines are ethylene diamine adducts of such polyoxyethylene, polyoxypropylene block copolymers available under the trade name Tetronic (BASF), including poloxamine 1107 (Tetronic 1 107 having a molecular weight from about 7,500 to about 27,000 wherein at least 40 weight percent of said adduct is poly(oxyethylene) having a HLB of 24. Other suitable non-ionic surfactants include for example but are not limited to polyethylene glycol esters of fatty acids, e.g. coconut, polysorbate, polyoxyethylene or polyoxypropylene ethers of higher alkanes (C₁₂-C₁₈), polysorbate 20 available under the trade name Tween® 20 (ICI Americas, Inc.), polyoxyethylene (23) lauryl ether available under the trade name Brij® 35 (ICI Americas, Inc.), polyoxyethyene (40) stearate available under the trade name Myrj52 (ICI Americas, Inc.) and polyoxyethylene (25) propylene glycol stearate available under the trade name Atlas® G 2612 (ICI Americas, Inc.).

Another useful class of surfactants are the hydroxyalkylphosphonates, such as those disclosed in U.S. Pat. No. 5,858,937 (Richards et al.), and available under the trade name Dequest® (Montsanto Co., St. Louis, Mo.).

Amphoteric surfactants suitable for use in a composition according to the present invention include materials of the type are offered commercially under the trade name Miranol™ (Noveon, Inc., Cleveland, Ohio). Another useful class of amphoteric surfactants is exemplified by cocoamidopropyl betaine, commercially available from various sources.

Various other ionic as well as amphoteric and anionic surfactants suitable for such compositions can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Preferably, the surfactants, when present, are employed in a total amount from about 0.01 to about 15 weight percent, preferably about 0.1 to about 9.0 weight percent, and most preferably about 0.1 to about 7.0 weight percent.

As an illustration of the present invention, several examples are provided below. These examples serve only to further illustrate aspects of the invention and should not be construed as limiting the invention.

### EXAMPLE 1

### Preparation of Test Solutions

Sample solutions for testing were prepared in accordance with the formulations set forth below in Table 1.

TABLE 1

Test Solution

| Ingredients % W/W | 1 | 2 |
|---|---|---|
| Pluronic F127 | 2.0000 | 2.0000 |
| Tetronic 1107 | 1.0000 | 1.0000 |
| Boric Acid | 0.8500 | 0.8500 |
| Monosodium Phosphate | 0.1500 | 0.1500 |
| Disodium Phosphate | 0.3100 | 0.3100 |
| Hydroxyalkylphosphonate | 0.1000 | 0.1000 |
| PHMB (ppm) | 1.2 | 0 |
| Alexidine 2HCl (ppm) | 0 | 4.5 |
| Polymer JR 30M | 0.0200 | 0.0200 |
| Sodium Chloride | 0.1917 | 0.1917 |
| Purified Water | Q.S. to 100 gm | Q.S. to 100 gm |

Pluronic F127 (BASF)
Tetronic 1107 (BASF)
Polymer JR 30M (Amerchol Corp.)

### EXAMPLE 2

### Test Solution 1 Stability Profile

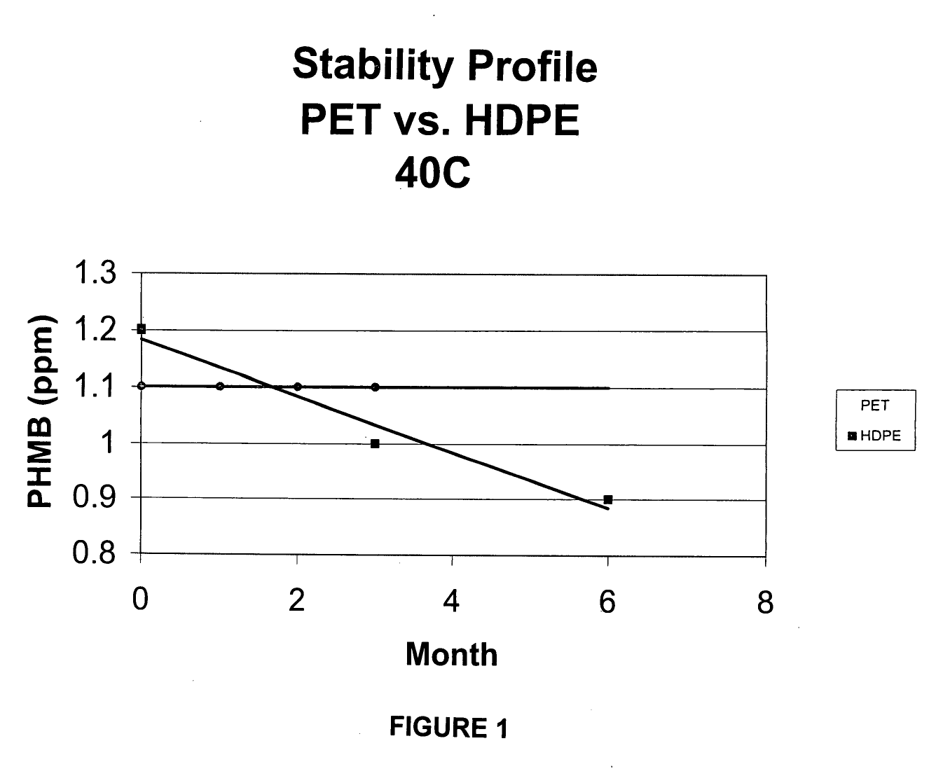

120 ml of Test Solution 1 was filled into each of three 4-ounce PET 7352 containers and three 4-ounce Marlex 5502BN HDPE containers and then stored at 40° C. Data was collected upon initiation and each month for six months. Collected data is set forth below in Table 2 and illustrated in FIG. 1.

TABLE 2
Test Solution 1

PHMB in ppm

| Month | PET Container | HDPE Container |
|---|---|---|
| 0 | 1.2 | 1.2 |
| | 1.1 | 1.2 |
| | 1.0 | 1.3 |
| 1 | ND | ND |
| | 1.1 | ND |
| | ND | ND |
| 2 | 1.2 | ND |
| | 1.1 | ND |
| | 1.1 | ND |
| 3 | 1.2 | 1.0 |
| | 1.1 | 1.0 |
| | 1.1 | 1.1 |
| 4 | 1.1 | ND |
| | 1.2 | ND |
| | 1.2 | ND |
| 5 | ND | ND |
| | ND | ND |
| | ND | ND |
| 6 | ND | 1.0 |
| | ND | 0.9 |
| | ND | 0.8 |

### EXAMPLE 3

### Test Solution 2 Stability Profile

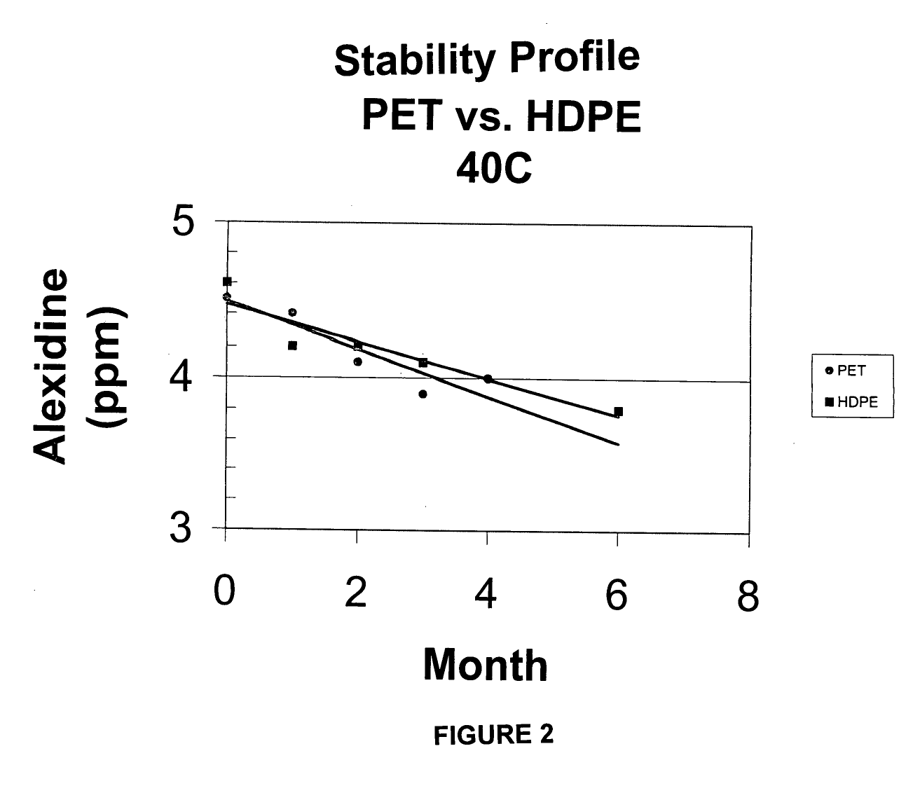

120 ml of Test Solution 2 was filled into each of three 4-ounce PET 7352 containers and three 4-ounce Marlex 5502BN HDPE containers and then stored at 40° C. Data was collected upon initiation and each month for six months. Collected data is set forth below in Table 3 and illustrated in FIG. 2.

TABLE 3
Test Solution 2

Alexidine in ppm

| Month | PET Container | HDPE Container |
|---|---|---|
| 0 | 4.6 | 4.6 |
| | 4.5 | 4.5 |
| | 4.5 | 4.6 |
| 1 | 4.4 | 4.3 |
| | ND | 4.2 |
| | ND | 4.2 |
| 2 | 4.2 | 4.2 |
| | 4.1 | 4.2 |
| | 4.1 | 4.2 |
| 3 | 3.8 | 4.0 |
| | 3.8 | 4.1 |
| | 4.1 | 4.1 |
| 4 | 4.0 | ND |
| | 4.0 | ND |
| | 4.0 | ND |
| 5 | ND | ND |
| | ND | ND |
| | ND | ND |
| 6 | ND | 3.9 |
| | ND | 3.7 |
| | ND | 3.7 |

### EXAMPLE 4

### Test Solution 1 ISO Stand-Alone Biocidal Efficacy Profile

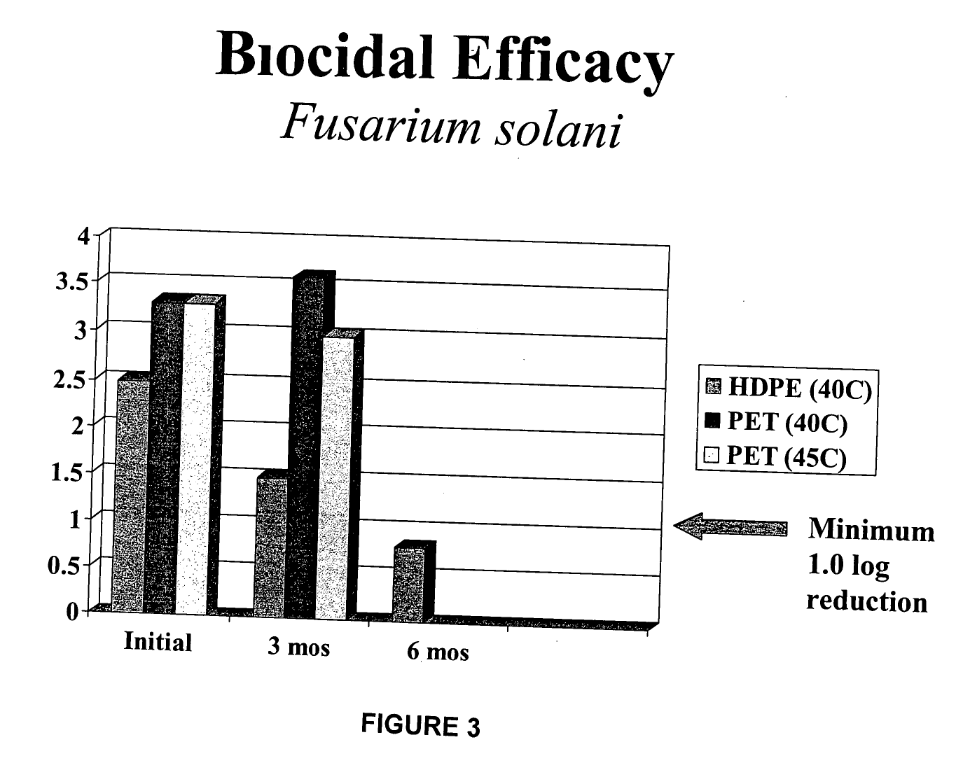

An ISO Stand-Alone Biocidal Efficacy study using 10 percent organic soil was conducted using Test Solution 1, whereby Test Solution 1 was tested against Staphococcus aureus ATCC 6538 (bacteria) and Fusarium solani ATCC 36031 (mold). The results of the Stand-Alone Biocidal Efficacy study are set forth below in Table 4 and illustrated in FIG. 3.

TABLE 4
Test Solution 1 ISO Stand-Alone Biocidal Efficacy Using
10 Percent Organic Soil and Accelerated Conditions
(40° C.)

| | | |
|---|---|---|
| Initial | 3 months | 6 months |

| Container | Sa | Fs | Sa | Fs | Sa | Fs |
|---|---|---|---|---|---|---|
| HDPE | 4.8 | 2.4 | 4.3 | 2.0 | 3.1 | 0.5 |
| | 4.8 | 2.2 | 4.7 | 1.2 | 2.9 | 1.1 |
| | 4.7 | 3.0 | >4.6 | 1.3 | 1.4 | 0.3 |
| Average | 4.8 | 2.5 | 4.5 | 1.5 | 2.5 | 0.7 |
| PET | >4.9 | 3.8 | >4.6 | 3.2 | >4.8 | 1.7 |
| | 4.4 | 3.2 | 4.9 | 3.8 | ND | ND |
| | 4.0 | 3.0 | >4.9 | 3.1 | >4.7 | 2.8 |
| Average | 4.4 | 3.3 | 4.8 | 3.4 | 4.8 | 2.3 |

ND = No Data
Sa = Staphococcus aureus
Fs = Fusarium solani

### EXAMPLE 5

### Test Solution 2 ISO Stand Alone Biocidal Efficacy Profile

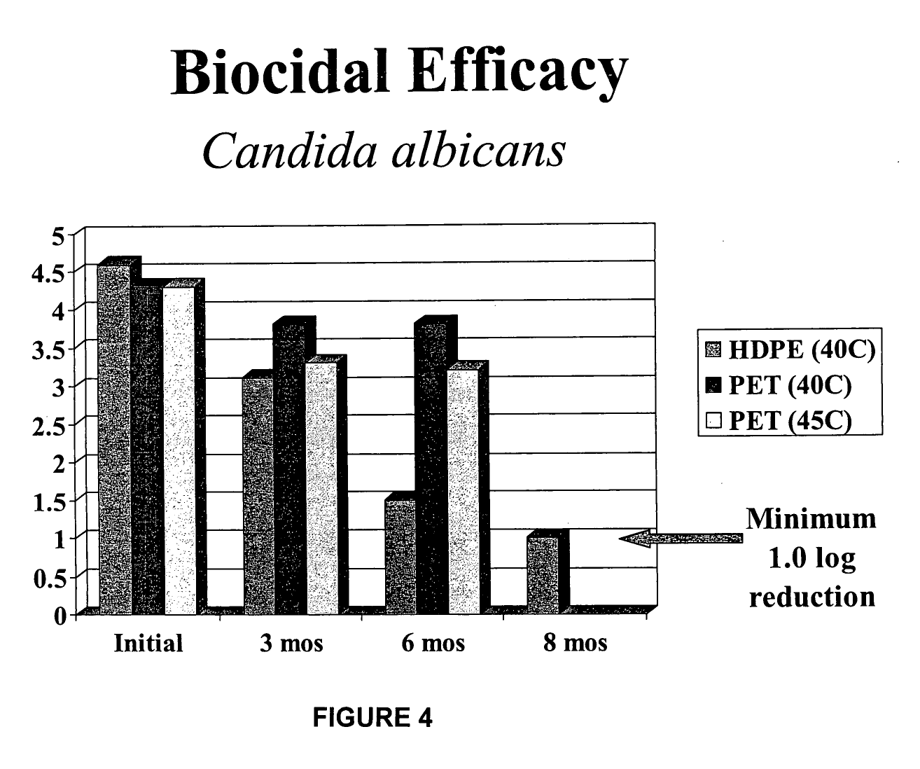

An ISO Stand-Alone Biocidal Efficacy study using 10 percent organic soil was conducted using Test Solution 2, whereby Test Solution 2 was tested against Candida albicans ATCC 10231 (mold). The results of the Stand-Alone Biocidal Efficacy study are set forth below in Table 5 and illustrated in FIG. 4.

TABLE 5
Test Solution 2 ISO Stand-Alone Biocidal Efficacy Using
10 Percent Organic Soil and Accelerated Conditions
(40° C.)

| | Initial | 3 months | 6 months | 8 months |
|---|---|---|---|---|
| Container | Ca | Ca | Ca | Ca |
| HDPE | 4.5 | 2.5 | 1.3 | 1.0 |
| | >4.6 | 3.8 | 1.2 | 0.7 |
| | 4.6 | 2.8 | 1.9 | 1.2 |
| Average | 4.6 | 3.1 | 1.5 | 1.0 |
| PET | 4.6 | 4.3 | 3.7 | ND |
| | 3.7 | 3.1 | 3.8 | ND |
| | 4.6 | 4.2 | 4.7 | ND |
| Average | 4.3 | 3.8 | 3.8 | ND |

ND = No Data
Ca = Candida albicans

Based on the findings of the above studies, the present invention comprises a method of enhancing antimicrobial efficacy of a lens care solution comprising packaging said solution in a container formed of PET resin.

Another method of the present invention comprises enhancing lens care solution stability and hence product shelf-life by packaging said solution in a container formed of PET resin.

Compositions useful as lens care solutions packaged in containers formed from PET resin as described in the present specification, may be packaged, sterilized and used in accordance with methods customary in the field of contact lens care.

Although various preferred embodiments have been illustrated, many other modifications and variations of the present invention are possible to the skilled practitioner. It is therefore understood that, within the scope of the claims, the present invention can be practiced other than as herein specifically described.

1. Compositions for contact lens care comprising:
one or more surfactants and one or more antimicrobial agents packaged in a container formed from poly(ethylene terephalate).

2. The composition of claim 1 wherein said one or more surfactants are selected from the group consisting of Pluronic P123™, Pluronic L42™, Pluronic L62™, Pluronic L72™, Pluronic L92™, Pluronic P103™, Pluronic R 12R3™, Pluronic R 17R1™, Pluronic R 17R2™, Pluronic R 31R1™ Pluronic R 31R2™, Pluronic R 31R4™, Tetronic 701™, Tetronic 702™, Tetronic 901™, Tetronic 1101™, Tetronic 1102™, Tetronic 1301™, Tetronic 1302™, Tetronic 1501™, Tetronic 1502™, Tetronic R 50R1™, Tetronic R 50R4™, Tetronic R 70R1™, Tetronic R 70R2™, Tetronic R 70R4™, Tetronic R 90R1™, Tetronic R 90R4™, Tetronic R 110R1™, Tetronic R 110R2™, Tetronic R 110R7™, Tetronic R 130R1™, Tetronic R 130R2™, Tetronic R 150R1™, Tetronic R 150R4™ and Tetronic R 150R8™.

3. The composition of claim 1, wherein the composition further comprises at least one member selected from the group consisting of a buffering agent, a chelating agent, an osmolarity adjusting agent, and a surfactant having a HLB of 18 or above.

4. The composition of claim 1, wherein said one or more antimicrobial agents are present in an amount effective to disinfect a contact lens.

5. The composition of claim 1 wherein the composition comprises about 0.1 to about 6.0 weight percent of said surfactant and about 0.05 to about 0.5 weight percent of said antimicrobial agent.

6. The composition of claim 1 wherein the composition further comprises a chelating agent and a buffering agent selected from the group consisting borate buffers, phosphate buffers and citrate buffers.

7. The composition of claim 6, wherein the composition comprises at least one member selected from the group consisting of poloxamer and poloxamine surfactants having HLB values of 18 or greater.

8. A method of enhancing biocidal efficacy of a lens care solution comprising:
packaging a lens care solution containing one or more surfactants and one or more antimicrobial agents in a container formed from poly(ethylene terephalate).

9. A method of enhancing stability of a lens care solution comprising:
packaging a lens care solution containing one or more surfactants and one or more antimicrobial agents in a container formed from poly(ethylene terephalate).

10. A method of increasing shelf-life of a lens care solution comprising:
packaging a lens care solution containing one or more surfactants and one or more antimicrobial agents in a container formed from poly(ethylene terephalate).

11. The method of claim 8, 9 or 10 wherein the solution further comprises at least one member selected from the group consisting of a buffering agent, a chelating agent, an osmolarity adjusting agent, and a surfactant having a HLB value of 18 or greater.

12. The method of claim 8, 9 or 10 wherein the solution further comprises an antimicrobial agent in an amount effective to disinfect a contact lens.

13. The method of claim 8, 9 or 10 wherein the solution comprises about 0.05 to about 0.5 weight percent of said antimicrobial agent.

14. The method of claim 8, 9 or 10 wherein the solution further comprises a chelating agent and a buffering agent selected from the group consisting borate buffers, phosphate buffers and citrate buffers.

15. The method of claim 8, 9 or 10 wherein the composition further comprises a surfactant having a HLB value of 18 or greater.

16. The method of claim 8, 9 or 10 wherein the solution comprises at least one member selected from the group consisting of poloxamer and poloxamine surfactants having a HLB value of 18 or greater.

17. The method of claim 8, 9 or 10 wherein said one or more surfactants are selected from the group consisting of Pluronic P123™, Pluronic L42™, Pluronic L62™, Pluronic L72™, Pluronic L92™, Pluronic P103™, Pluronic R 12R3™, Pluronic R 17R1™, Pluronic R 17R2™, Pluronic R 31R1™, Pluronic R 31R2™, Pluronic R 31R4™, Tetronic 701™, Tetronic 702™, Tetronic 901™, Tetronic 1101™, Tetronic 1102™, Tetronic 1301™, Tetronic 1302™, Tetronic 1501™, Tetronic 1502™, Tetronic R 50R1™, Tetronic R 50R4™, Tetronic R 70R1™, Tetronic R 70R2™, Tetronic R 70R4™, Tetronic R 90R1™, Tetronic R 90R4™, Tetronic R 110R1 ™, Tetronic R 110R2™, Tetronic R 110R7™, Tetronic R 130R1™, Tetronic R 130R2™, Tetronic R 150R1™, Tetronic R 150R4™ and Tetronic R 150R8™.
